(19) United States
(12) Patent Application Publication
(10) Pub. No.: US 2026/0228922 A1
(43) Pub. Date: Aug. 6, 2026

(54) BITRATE ADAPTATION FOR EDGE-ASSISTED LOCALIZATION GIVEN NETWORK AVAILABILITY FOR MOBILE DEVICES

(71) Applicant: TELEFONAKTIEBOLAGET LM ERICSSON (PUBL), STOCKHOLM (SE)

(72) Inventors: José Araújo, Stockholm (SE); Yakov Teplitsky, Cupertino, CA (US); Per-Erik Brodin, Scotts Valley, CA (US); André Mateus, Uppsala (SE); Paula Carbó Cubero, Stockholm (SE)

(21) Appl. No.: 19/142,578

(22) PCT Filed: Dec. 23, 2022
(86) PCT No.: PCT/US2022/053968

§ 371 Date: Jun. 23, 2025

(51) Int. Cl. G06T 9/00; G06T 7/20; G06T 7/579; G06T 11/65; H04W 64/00

(52) U.S. Cl. CPC G06T 9/00; G06T 7/20; G06T 7/579; G06T 11/65; H04W 64/006; G06T 2210/08

(57) ABSTRACT

The present disclosure provides system and methods of bitrate adaptation for edge-assisted simultaneous localization and mapping (SLAM) where the bitrate of image data sent from a remote device to an edge device or server, can be dynamically adapted based on network availability. A model can be constructed offline that determines an optimal bitrate for the image data sent to a network node of a wireless communication system to improve and/or maximize localization performance based on a set of parameters including network latency, whether a map of an environment is present, and the bitrate of the map. The network latency can be determined based on another model that determines the latency as a function of the image data bitrate and network availability. Once the bitrate is determined, the image data can be compressed such that the compressed image data is transmitted to the network node at the determined bitrate.

### TECHNICAL FIELD

The present disclosure relates to bitrate adaptation for edge-assisted localization based on network availability in a wireless communications system.

### BACKGROUND

Simultaneous localization and mapping (SLAM) is a technique used by robots and autonomous vehicles to build a map of their surroundings while simultaneously keeping track of their own location within that map. This allows the robot or vehicle to navigate its environment in a more intelligent and efficient way, using the map it has built to plan its movements and avoid obstacles. SLAM algorithms typically combine data from a variety of sensors, such as cameras, lidar, and odometry, to create a consistent and accurate map of the environment.

SLAM algorithms are energy intensive however, and there are benefits to offloading localization and mapping algorithms to from the device to a server such as an edge device or cloud server. This can greatly increase the device battery lifetime even when considering the cost of streaming raw sensor data to the edge/cloud in real-time. However, such streaming imposes a heavy demand on the network. Image data and other raw sensor data can be compressed to ease the bandwidth constraints, but there are tradeoffs with respect to performance of localization and mapping. By performance of the localization, this can refer to the accuracy of the localization, but also to the latency of localization, which if the device is moving, can also impact the accuracy of the localization.

When evaluating the localization performance as a function of the bitrate of the image data or sensor data, it is possible to find a minimum bitrate for the image or sensor data for which acceptable localization performance can be achieved. If the bitrate drops below this minimum bitrate, the localization performance may degrade significantly. This is shown for example in FIG. 1, which depicts a graph 100 of localization error 102 in meters versus image bitrate 104 for a map of a fixed bitrate value where a drone flies inside a factory in an easy scenario (low speed, good lighting conditions). As the image bitrate falls to around 600, the error value of the Root Mean Square Error (RMSE) value 106 start increasing slightly, but the minimum/maximum error range shown in shading 108 shows a much larger increase.

When evaluating the localization performance as a function of latency, the higher the latency the worse the localization performance, but also that the higher the speed of the device, the higher impact the latency has. For example, on the datasets that were evaluated of a drone flying in a factory with various degrees of difficulty (lower/higher speeds, darker/brighter environments), for every added 10 ms of network latency, the error increased by 1 to 3 cm, depending on the speed of the device. This is shown in FIG. 2, where graph 200 depicts localization error 202 in meters as a function of network latency 204 in milliseconds. The drone flying at low speed depicted in line 210 has a similar performance as line 212, but for increased flying speed depicted by lines 206 and 208, the network latency has a much larger effect on localization error.

### SUMMARY

The present disclosure provides system and methods of bitrate adaptation for edge-assisted simultaneous localization and mapping (SLAM) where the bitrate of image data sent from a remote device to an edge device or server, can be dynamically adapted based on network availability. A model can be constructed offline that determines an optimal bitrate for the image data sent to a network node of a wireless communication system to improve and/or maximize localization performance based on a set of parameters including network latency, whether a map of an environment is present, and the bitrate of the map. The network latency can be determined based on another model that determines the latency as a function of the image data bitrate and network availability. Once the bitrate is determined, the image data can be compressed such that the compressed image data is transmitted to the network node at the determined bitrate.

In an embodiment, a method performed by a mobile device for compressing image data for simultaneous localization and mapping is provided. The method includes receiving image data of an environment from an image sensor of the mobile device at a first bitrate. The method also includes receiving a first model that predicts localization performance as a function of: network latency, the first bitrate of the image data, whether a map of the environment is present, and in response to the map of the environment being present, a second bitrate of a map of the environment. The method also includes determining, utilizing the first model, a second bitrate for transmission of image data that improves the localization performance. The method also includes encoding the image data at the second bitrate to generate compressed image data, and transmitting the compressed image data to a network node.

In another embodiment, a mobile device can be provided that is configured to compress image data for simultaneous localization and mapping. The mobile device can include a radio interface and processing circuitry that can receive image data of an environment from an image sensor of the mobile device at a first bitrate. The processing circuitry can also receive a first model that predicts localization performance as a function of: network latency, the first bitrate of the image data, whether a map of the environment is present, and in response to the map of the environment being present, a second bitrate of a map of the environment. The processing circuitry can also determine, utilizing the first model, a second bitrate for transmission of image data that improves the localization performance. The processing circuitry can also encode the image data at the second bitrate to generate compressed image data and transmit the compressed image data to a network node.

In another embodiment, a non-transitory computer readable medium can be provided that comprises instructions, that when executed by a processor, perform operations including receiving image data of an environment from an image sensor of the mobile device at a first bitrate. The operations also include receiving a first model that predicts localization performance as a function of: network latency, the first bitrate of the image data, whether a map of the environment is present, and in response to the map of the environment being present, a second bitrate of a map of the environment. The operations also include determining, utilizing the first model, a second bitrate for transmission of image data that improves the localization performance. The operations also include encoding the image data at the second bitrate to generate compressed image data, and transmitting the compressed image data to a network node.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a graph depicting localization error as a function of image bitrate;

FIG. 2 illustrates a graph depicting localization error as a function of network latency for devices at a variety of speeds;

FIG. 3 illustrates a message sequence chart for compressing data for simultaneous localization and mapping according to some embodiments of the present disclosure;

FIG. 4 illustrates one example of a cellular communications system according to some embodiments of the present disclosure;

FIG. 5 is a schematic block diagram of a network node according to some embodiments of the present disclosure;

FIG. 6 is a schematic block diagram that illustrates a virtualized embodiment of the network node of FIG. 5 according to some embodiments of the present disclosure;

FIG. 7 is a schematic block diagram of the network node of FIG. 5 according to some other embodiments of the present disclosure;

FIG. 8 is a schematic block diagram of a User Equipment (UE) device according to some embodiments of the present disclosure; and

FIG. 9 is a schematic block diagram of the UE of FIG. 8 according to some other embodiments of the present disclosure.

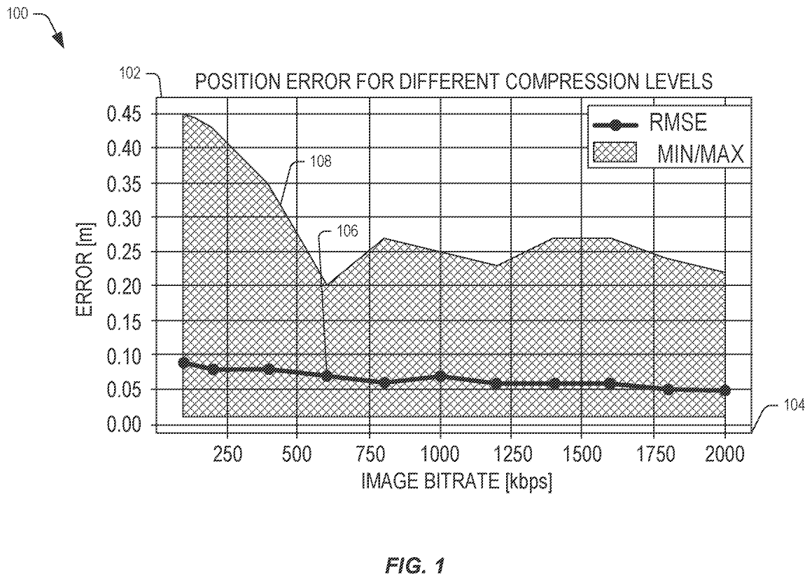

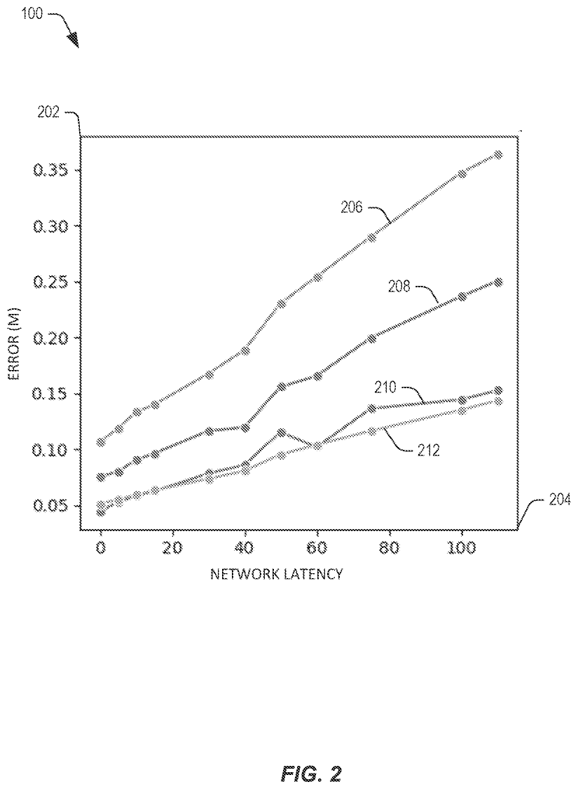

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Mobile Device: A mobile device is any type of wireless device that has access to (i.e., is served by) a wireless network (e.g., a cellular network). Some examples of a mobile device include, but are not limited to: a User Equipment device (UE) in a Third Generation Partnership Project (3GPP) network, a Machine Type Communication (MTC) device, and an Internet of Things (IoT) device. Such devices may be, or may be integrated into, a mobile device such as, e.g., a mobile phone, smart phone, vehicle, virtual reality (VR) glasses, augmented reality (AR) glasses, robotic device, or the like, or integrated into any type of device for which localization is desired. The mobile device may be enabled to communicate voice and/or data via a wireless connection.

Network Node: As used herein, a “network node” is any node that is either part of the radio access network (RAN) or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to Fifth Generation (5G) New Radio (NR) concepts, beams may be used instead of cells and, as such, it is important to note that the concepts described herein are equally applicable to both cells and beams.

The present disclosure provides system and methods of bitrate adaptation for edge-assisted simultaneous localization and mapping (SLAM) where the bitrate of image data sent from a remote device to an edge device or server, can be dynamically adapted based on network availability. A model can be constructed offline that determines an optimal bitrate for the image data sent to a network node of a wireless communication system to improve and/or maximize localization performance based on a set of parameters including network latency, whether a map of an environment is present, and the bitrate of the map. The network latency can be determined based on another model that determines the latency as a function of the image data bitrate and network availability. Once the bitrate is determined, the image data can be compressed such that the compressed image data is transmitted to the network node at the determined bitrate.

It is to be appreciated that in the present disclosure, while reference is made to capturing, encoding, compressing, and/or transmitting images, these images can be frames of a video stream that are encoded and compressed via a video codec such as AVC/H.264, HEVC/H.265, VVC/H.266, or similar. The video stream comprises the images at a certain rate or frames per second, and with a bitrate that is controlled by the video codec. Alternatively, the images can be individual images that are not part of a video stream, but are individually encoded and/or compressed to a certain size, where the bitrate of the encoded and/or compressed images corresponds to a function of the size of the images and the rate at which the images are transmitted.

When performing server-assisted localization of a device, the volumes of data to be transmitted over the network are very large. This brings the need to compress this data and bitrate adaptation algorithms which determine the desired bitrate for an image stream given the available network bandwidth available. However, such bitrate adaptation mechanisms do not attempt to optimize the performance of the localization process which runs in the server in order to maximize its accuracy/minimize the localization error.

In an embodiment, the localization error can be dependent on the device-server latency, but it is also dependent on the bitrate that is used to encode the images transmitted to the server. Moreover, the data bitrate affects the transmission latency over a network. The present disclosure provides a method which determines the image bitrate which optimizes the localization performance (minimizes the localization error), by taking into account the impact that the image bitrate and the transmission latency have on the localization performance via a model of these effects which can be constructed offline. A principle of the present disclosure is that data bitrate will be determined in a way that it optimizes the SLAM performance, considering that a certain data bitrate will generate an expected level of network latency, and considering that both bitrate and latency have a certain impact in the SLAM performance

An advantage of the proposed method is that the impact of data bitrate and network latency is considered directly in the decision making, which enables the optimization of the performance of server-assisted localization.

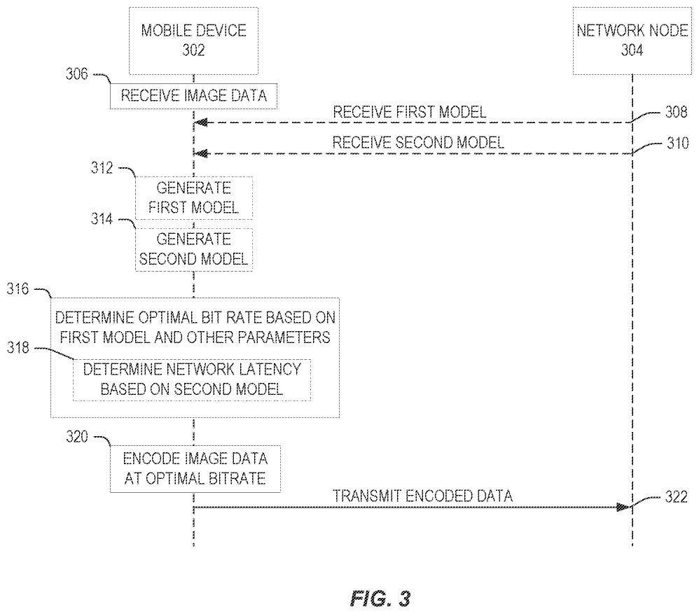

FIG. 3 illustrates a message sequence chart for compressing data for simultaneous localization and mapping according to some embodiments of the present disclosure. The message sequence chart describes the operations and transmissions of data between a mobile device 302 and a network node 304.

At step 306, the mobile device 102, can receive image data from an image sensor, where the image data represents an image of an environment around the mobile device 302. In an embodiment, the mobile device 302 can have the image sensor built into the mobile device 302. In other embodiments, the image sensor can be attached to, or otherwise be communicably coupled to the mobile device 302. The image sensor could be digital cameras such as one or more of charge-coupled device (CCD) sensors or complementary metal-oxide-semiconductor (CMOS) sensors, or other device types. The image sensor could also be in the form of a lidar or radar detector, or ultrasound sensor, or any other sensor system that can identify objects, obstacles, and other features of an environment. In an embodiment, the rate at which image data is captured by the sensor can be dependent on the SLAM algorithm, which generally can be between 20-30 Hz. Thus between 20 and 30 times every second, the mobile device 302 receives a new set of image data corresponding to an image of the environment around the mobile device 302.

For the next step, the mobile device 302 receives a first model that can be used to predict localization performance of edge-assisted SLAM as a function of a set of parameters that include network latency, a first bitrate (which corresponds to the resolution) of image data to be sent to the network node 304, whether a map of the environment is present, the second bitrate of the map, if the map is present and optionally, the speed of the mobile device 302. The mobile device 302 can either generate the first model at step 312, or receive the model at step 308 if the network node 304 or other edge or server device constructed the model offline. It is to be appreciated that while FIG. 3 depicts the image data being received at step 306 before the first model is received or generated at steps 308 and 312, in some embodiments, the first model can be received or generated before the image data is received.

The mobile device 302 also receives a second model that can be used to predict network latency as a function of the first bitrate of the image data and network bandwidth that is available. The mobile device 302 can either generate the first model at step 314, or receive the model at step 310 if the network node 304 or other edge or server device constructed the model offline. It is to be appreciated that while FIG. 3 depicts the image data being received at step 306 before the second model is received or generated at steps 310 and 314, in some embodiments, the second model can be received or generated before the image data is received or before the first model is received or generated.

The term localization performance as used herein refers to the accuracy and/or efficiency of localization performed during the edge assisted SLAM process. Accuracy could refer to the error (e.g., the location could be at x location+/−0.5 m). The accuracy could also be a reference to the circular error probability, or likelihood that the device is within different ranges of the identified location. The efficiency could refer to the time and/or energy it takes to perform the SLAM process.

With regard to the first model, it was described above how the localization accuracy depends on the image bitrate. By collecting this data, the a first system can be built which predicts the localization performance given an image data bitrate. In an embodiment, the resolution can correspond to a bitrate and as the resolution changes, the bitrate changes. In other embodiments, depending on the codecs used to encode the images or video stream, for a given resolution, the bitrate of the images or video stream can vary, and to transmit the increased amount of image data in the relevant time windows, the bitrate of the transmission increases, provided the sampling rate stays relatively stable. Furthermore, it has been observed that this relation depends also if a map is available or not, and what bitrate the map was built on. As above with reference to the image data bitrate, the bitrate of the map corresponds to the resolution of the map data used to create the relevant portion of the map. In an embodiment, the system can be expressed as: localization_error=model_error_bitrate(image bitrate, map/no map, map bitrate).

The localization performance can also depend on the network latency as described above. By collecting this data, another system can be built which predicts the localization accuracy given the network latency. Furthermore, it has been observed that this relation depends also if a map is available or not, and also depends on the speed at which the device moves in the environment. In some embodiments, the localization performance can also be based on a function of image complexity, which corresponds to the complexity or features present in the environment around the mobile device 302. For example, very obvious, high contrast features, such as sharp angles, well illuminated images, etc., will be easier for the SLAM process to identify the location based on such features. In summary, the system can be expressed as: localization_error=model_error_latency(network latency, map/no map, device speed).

Now given these two systems a model (e.g., the first model) can be constructed which relates bitrate, network latency and localization error, as follows: localization_error=model_error_latency_bitrate(network latency, image bitrate, map/no map, map_bitrate, device speed). Such a model can be trained with any system identification/modelling methods such as regression or neural network methods, which determine the model output as a linear, nonlinear or neural network function of the inputs, given training data that include the inputs and the respective outputs.

With regard to the second model, bitrate adaptation algorithms (e.g., self-clocked rate adaptation for multimedia (SCReAM)) define what should be the image bitrate given the available network bandwidth to minimize the network latency affecting the transmitted image data. These algorithms can estimate the expected network latency given the desired bitrate, where the network latency increases when the bitrate increases and vice versa, subject to the available network bandwidth. Such a model can be extracted from such rate adaptation algorithms as follows: network latency=model_latency_bitrate(bitrate, network bandwidth). As described above, in some embodiments, the network node 304 or another server (e.g., SLAM server 416), may have constructed the first model and second model offline and provided the first model and second model to the mobile device at steps 308 and 310 respectively.

Maintaining a target bitrate is difficult in wireless communication systems, as is maintaining link capacity, but modern 5G wireless communication systems can provide the stability for the techniques disclosed herein. Quality of Service (QoS) standards will be provided to devices such as robots and extended reality (XR) glasses performing SLAM. XR glasses include head-mounted devices, including head-mounted displays such as virtual reality (VR) glasses and augmented reality (AR) glasses. In particular, this will be true in well managed networks such as indoor deployments in factories where multiple robots have to operate with as high quality of service as possible.

At step 316, the mobile device 302 can determine, utilizing the first model, a second bitrate the transmission of image data that improves the localization performance. Given the first model described above, the mobile device 302 can determine which bitrate gives an improved, or even an optimal localization performance, given the other parameters of network latency, whether or not a map is present, bitrate of the map, device speed, and etc. This allows then for the bitrate adaptation mechanism to infer what could be the best bitrate value to be set which obtains the lowest localization error or best localization performance, where the relationship between bitrate and network latency is captured. This results in the following optimization problem to be solved as:

$$desired\_bitrate = arg {min}_{bitrate} localization\_error ,$$

$$where$$

$$localization\_error = model\_error \_latency \text{} \_bitrate ( model\_latency \_bitrate ( bitrate , netwrok bandwidth ) , bitrate , map / no map , map\_bitrate , device speed )$$

Such an optimization problem can be solved in a simple manner by performing a search over a reasonable bitrate range, for the current or predicted values of network bandwidth, map availability, the current map bitrate and also the current or predicted device speed. In an embodiment, the predicted values can be based on identifying trends based on past values. In another embodiment, the optimization problem can be solved using existing multi-objective optimization tools (e.g., Hypermapper).

In an embodiment, the bitrate range used in the previous step can be first determined by a rate adaptation algorithm, and then a range around that value can be searched for optimality, as for example a range defined as [algorithm predicted bitrate+/−500 kpbs]. In this way, small adjustments are performed over what the bitrate adaptation algorithm suggests in order to take into account that the localization performance also depends on the network latency that will result of such bitrate.

In an embodiment, the network latency that is used by the first model to determine the second bitrate, can be received at step 315 from the network node 304. In other embodiments, the network latency can be determined by the mobile device 302 at step 318 based on the second model above where the network latency is a function of bitrate and network bandwidth (network latency=model_latency_bitrate(bitrate, network bandwidth)).

Once the second bitrate, or the bitrate which has been determined to improve or optimize localization performance has been determined at step 316, the mobile device 302 can encode the image data at step 320 to create compressed image data that is compressed to size such that it can be transmitted to the network node 304 at step 322 at the second bitrate.

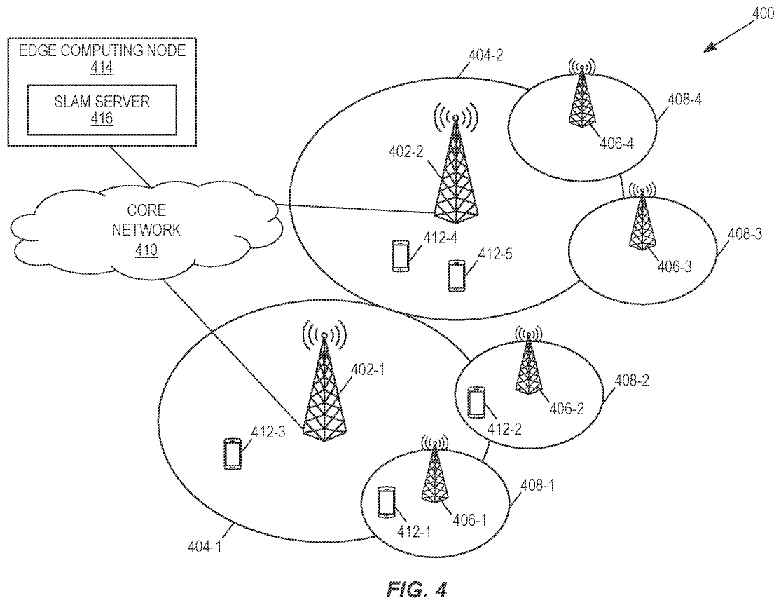

FIG. 4 illustrates one example of a cellular communications system 400 in which embodiments of the present disclosure may be implemented. In the embodiments described herein, the cellular communications system 400 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 402-1 and 402-2, which in the 5GS include NR base stations (gNBs) and optionally next generation eNBs (ng-eNBs) (e.g., Long Term Evolution (LTE) RAN nodes connected to the 5GC) and in the EPS include eNBs, controlling corresponding (macro) cells 404-1 and 404-2. The base stations 402-1 and 402-2 are generally referred to herein collectively as base stations 402 and individually as base station 402. Likewise, the (macro) cells 404-1 and 404-2 are generally referred to herein collectively as (macro) cells 404 and individually as (macro) cell 404. The RAN may also include a number of low power nodes 406-1 through 406-4 controlling corresponding small cells 408-1 through 408-4. The low power nodes 406-1 through 406-4 can be small base stations (such as pico or femto base stations) or Remote Radio Heads (RRHs), or the like. Notably, while not illustrated, one or more of the small cells 408-1 through 408-4 may alternatively be provided by the base stations 402. The low power nodes 406-1 through 406-4 are generally referred to herein collectively as low power nodes 406 and individually as low power node 406. Likewise, the small cells 408-1 through 408-4 are generally referred to herein collectively as small cells 408 and individually as small cell 408. The cellular communications system 400 also includes a core network 410, which in the 5G System (5GS) is referred to as the 5GC. The base stations 402 (and optionally the low power nodes 406) are connected to the core network 410.

Any of the base stations 402, or the low power nodes 406 can be the network node 304 to which the mobile device 302 communicate and transmit encoded and/or compressed image data. The SLAM can be performed at the base stations 402 or low power nodes 406, or can alternatively the SLAM can be performed at another server such as in the core network 410 or elsewhere.

The base stations 402 and the low power nodes 406 provide service to mobile devices 412-1 through 412-5 in the corresponding cells 404 and 408. The mobile devices 412-1 through 412-5 are generally referred to herein collectively as mobile devices 412 and individually as mobile device 412. In the following description, the mobile devices 412 are oftentimes UEs, but the present disclosure is not limited thereto.

The system 400 also includes an edge computing node 414 including a SLAM server 416 where the SLAM processing of the encoded data sent to the network node 304 at step 322 can be processed. In an embodiment, as depicted in FIG. 4, the edge computing node 414 is separate from the core network 410. In other embodiments however, the edge computing node 414 and SLAM server 416 can be operable on a device within the core network 410, or even in a base station 402 or low power node 406. If the network node 304 and the edge computing node 414 are not collocated, the network node 404 can forward the encoded data to the edge computing node 414. Likewise, the edge computing node 414 can provide the map data to the network node 304 to be provided to mobile device 302.

FIG. 5 is a schematic block diagram of a network node 500 according to some embodiments of the present disclosure. Optional features are represented by dashed boxes. The network node 500 may be, for example, a base station 402 or 406 or a network node that implements all or part of the functionality of the base station 402 or gNB described herein. The network node 500 can be the network node 304 that transmits map data to the mobile device 302 and receives the encoded and/or compressed image data from the mobile device 302. In some embodiments, the network node 500 can perform localization of the mobile device 302 based on the received encoded/compressed image data. As illustrated, the network node 500 includes a control system 502 that includes one or more processors 504 (e.g., Central Processing Units (CPUs), Application Specific Integrated Circuits (ASICs), Field Programmable Gate Arrays (FPGAs), and/or the like), memory 506, and a network interface 508. The one or more processors 504 are also referred to herein as processing circuitry. In addition, the network node 500 may include one or more radio units 510 that each includes one or more transmitters 512 and one or more receivers 514 coupled to one or more antennas 516. The radio units 510 may be referred to or be part of radio interface circuitry. In some embodiments, the radio unit(s) 510 is external to the control system 502 and connected to the control system 502 via, e.g., a wired connection (e.g., an optical cable). However, in some other embodiments, the radio unit(s) 510 and potentially the antenna(s) 516 are integrated together with the control system 502. The one or more processors 504 operate to provide one or more functions of a network node 500 as described herein. In some embodiments, the function(s) are implemented in software that is stored, e.g., in the memory 506 and executed by the one or more processors 504.

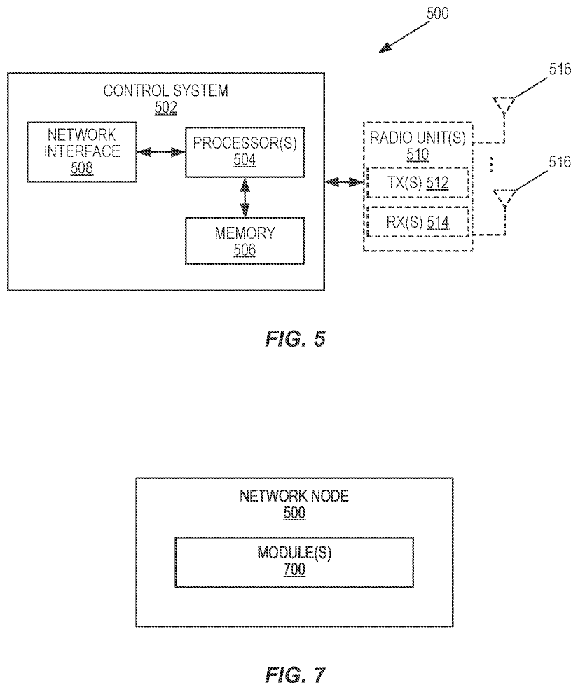

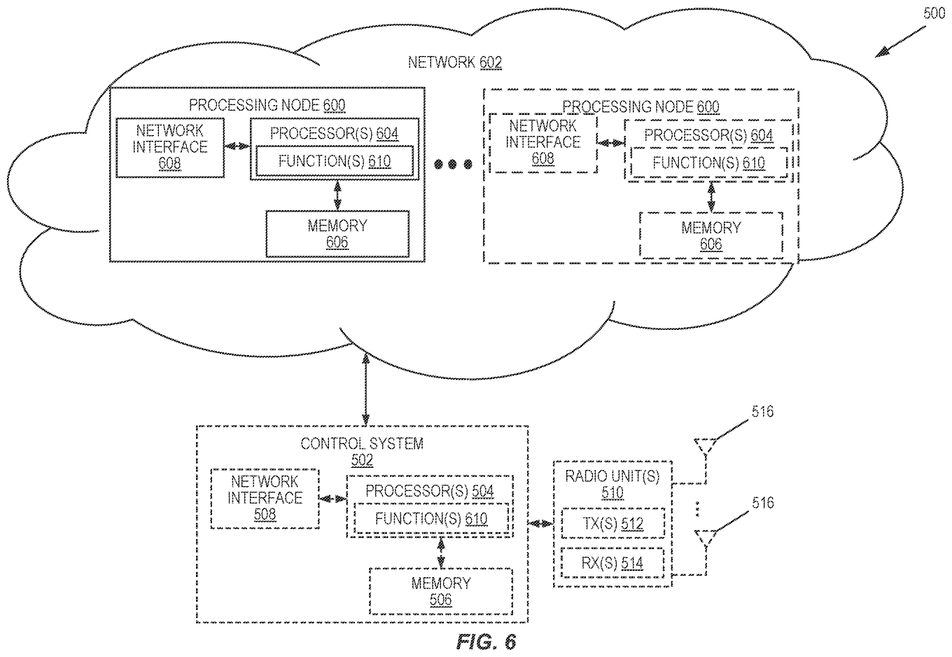

FIG. 6 is a schematic block diagram that illustrates a virtualized embodiment of the network node 500 according to some embodiments of the present disclosure. This discussion is equally applicable to other types of network nodes. Further, other types of network nodes may have similar virtualized architectures. Again, optional features are represented by dashed boxes.

As used herein, a “virtualized” network node is an implementation of the network node 500 in which at least a portion of the functionality of the network node 500 is implemented as a virtual component(s) (e.g., via a virtual machine(s) executing on a physical processing node(s) in a network(s)). As illustrated, in this example, the network node 500 may include the control system 502 and/or the one or more radio units 510, as described above. The control system 502 may be connected to the radio unit(s) 510 via, for example, an optical cable or the like. The network node 500 includes one or more processing nodes 600 coupled to or included as part of a network(s) 602. If present, the control system 502 or the radio unit(s) are connected to the processing node(s) 600 via the network 602. Each processing node 600 includes one or more processors 604 (e.g., CPUs, ASICs, FPGAs, and/or the like), memory 606, and a network interface 608.

In this example, functions 610 of the network node 500 described herein are implemented at the one or more processing nodes 600 or distributed across the one or more processing nodes 600 and the control system 502 and/or the radio unit(s) 510 in any desired manner. In some particular embodiments, some or all of the functions 610 of the network node 500 described herein are implemented as virtual components executed by one or more virtual machines implemented in a virtual environment(s) hosted by the processing node(s) 600. As will be appreciated by one of ordinary skill in the art, additional signaling or communication between the processing node(s) 600 and the control system 502 is used in order to carry out at least some of the desired functions 610. Notably, in some embodiments, the control system 502 may not be included, in which case the radio unit(s) 510 communicate directly with the processing node(s) 600 via an appropriate network interface(s).

In some embodiments, a computer program including instructions which, when executed by at least one processor, causes the at least one processor to carry out the functionality of network node 500 or a node (e.g., a processing node 600) implementing one or more of the functions 610 of the network node 500 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 7 is a schematic block diagram of the network node 500 according to some other embodiments of the present disclosure. The network node 500 includes one or more modules 700, each of which is implemented in software. The module(s) 700 provide the functionality of the network node 500 described herein. This discussion is equally applicable to the processing node 600 of FIG. 6 where the modules 700 may be implemented at one of the processing nodes 600 or distributed across multiple processing nodes 600 and/or distributed across the processing node(s) 600 and the control system 502.

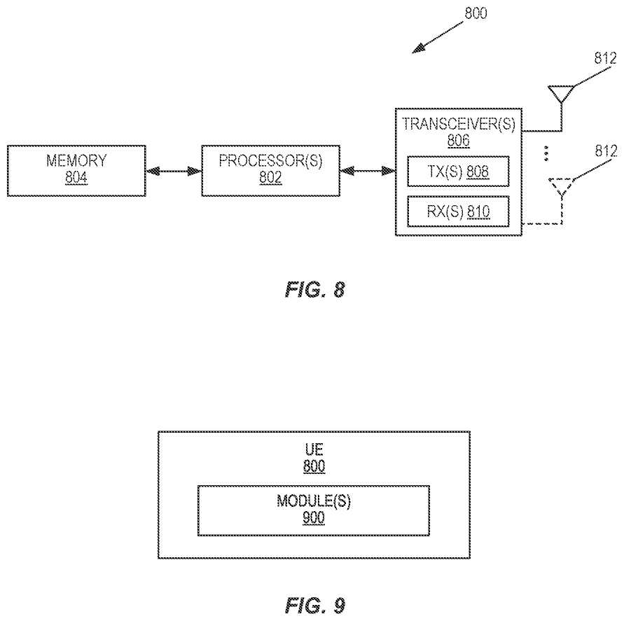

FIG. 8 is a schematic block diagram of a mobile device 800 according to some embodiments of the present disclosure. The mobile device 800 as described herein could be an example of the mobile device 302 described above. As illustrated, the mobile device 800 includes one or more processors 802 (e.g., CPUs, ASICs, FPGAs, and/or the like), memory 804, and one or more transceivers 806 each including one or more transmitters 808 and one or more receivers 810 coupled to one or more antennas 812. The transceiver(s) 806 includes radio-front end circuitry connected to the antenna(s) 812 that is configured to condition signals communicated between the antenna(s) 812 and the processor(s) 802, as will be appreciated by on of ordinary skill in the art. The processors 802 are also referred to herein as processing circuitry. The transceivers 806 are also referred to herein as radio circuitry. In some embodiments, the functionality of the mobile device 800 described above may be fully or partially implemented in software that is, e.g., stored in the memory 804 and executed by the processor(s) 802. Note that the mobile device 800 may include additional components not illustrated in FIG. 8 such as, e.g., one or more user interface components (e.g., an input/output interface including a display, buttons, a touch screen, a microphone, a speaker(s), and/or the like and/or any other components for allowing input of information into the mobile device 800 and/or allowing output of information from the mobile device 800), a power supply (e.g., a battery and associated power circuitry), etc.

In some embodiments, a computer program including instructions which, when executed by at least one processor, causes the at least one processor to carry out the functionality of the mobile device 800 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 9 is a schematic block diagram of the mobile device 800 according to some other embodiments of the present disclosure. The mobile device 800 includes one or more modules 900, each of which is implemented in software. The module(s) 900 provide the functionality of the mobile device 800 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AMF Access and Mobility Function
AN Access Network
ASIC Application Specific Integrated Circuit
AUSF Authentication Server Function
CCD Charged Coupled Device
CMOS Complementary Metal-Oxide-Semiconductor
CPU Central Processing Unit
DN Data Network
DSP Digital Signal Processor
eNB Enhanced or Evolved Node B
EPC Evolved Packet Core
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IoT Internet of Things
LTE Long Term Evolution
MTC Machine Type Communication
NEF Network Exposure Function
NF Network Function
NR New Radio
PC Personal Computer
QoS Quality of Service
RAM Random Access Memory
RAN Radio Access Network
RMSE Root Mean Square Error
ROM Read Only Memory
RRH Remote Radio Head
SLAM Simultaneous Localization and Mapping
UE User Equipment
XR Extended Reality

Those skilled in the art will recognize improvements and modifications to the embodiments of the present disclosure. All such improvements and modifications are considered within the scope of the concepts disclosed herein.

1. A method performed by a mobile device for compressing image data for simultaneous localization and mapping, comprising:
receiving image data of an environment from an image sensor of the mobile device at a first bitrate;
receiving a first model that predicts localization performance as a function of:
network latency, and
the first bitrate of the image data;
determining, utilizing the first model, a second bitrate for transmission of image data that improves the localization performance;
encoding the image data at the second bitrate to generate compressed image data; and
transmitting the compressed image data to a network node.

2. The method of claim 1, wherein the first model predicts localization performance further as a function of a speed of the mobile device.

3. The method of claim 1, wherein the first model predicts localization performance further as a function of:
whether a map of the environment is present; and
in response to the map of the environment being present, a second bitrate of a map of the environment.

4. The method of claim 3, wherein determining the second bitrate is based on current values for the network latency, the presence of the map of the environment, the second bitrate of the map of the environment, and the speed of the mobile device.

5. The method of claim 3, wherein determining the second bitrate is based on predicted values for the network latency, the presence of the map of the environment, the second bitrate of the map of the environment, and the speed of the mobile device.

6. The method of claim 5, wherein the predicted values are based on past values for the network latency, the presence of the map of the environment, the second bitrate of the map of the environment, and the speed of the mobile device.

7. The method of claim 1, further comprising:
determining the network latency based on a second model that determines network latency as a function of the first bitrate and network bandwidth.

8. The method of claim 7, further comprising:
receiving the first model and the second model from the network node.

9. The method of claim 7, further comprising:
generating the first model and the second model at the mobile device.

10. The method of claim 1, wherein a change in the network latency corresponds to a change in the first bitrate.

11-12. (canceled)

13. The method of claim 1, further comprising:
receiving the network latency from the network node.

14. A mobile device configured to compress image data for simultaneous localization and mapping, the mobile device comprising a radio interface and processing circuitry configured to:
receive image data of an environment from an image sensor of the mobile device at a first bitrate;
receive a first model that predicts localization performance as a function of:
network latency, and
the first bitrate of the image data;
determine, utilizing the first model, a second bitrate for transmission of image data that improves the localization performance;
encode the image data at the second bitrate to generate compressed image data; and
transmit the compressed image data to a network node.

15. The mobile device of claim 14, wherein the first model predicts localization performance further as a function of a speed of the mobile device.

16. The mobile device of claim 14, wherein the first model predicts localization performance further as a function of:
whether a map of the environment is present, and
in response to the map of the environment being present, a second bitrate of a map of the environment.

17. The mobile device of claim 16, wherein the processing circuitry is further configured to:
receive the first model and the second model from the network node.

18. The mobile device of claim 16, wherein the processing circuitry is further configured to:
generate the first model and the second model at the mobile device.

19. The mobile device of claim 14, wherein a change in the network latency corresponds to a change in the first bitrate.

20-21. (canceled)

22. The mobile device of claim 16, wherein determining the second bitrate is based on current values for the network latency, the presence of the map of the environment, the second bitrate of the map of the environment, and the speed of the mobile device.

23. The mobile device of claim 16, wherein determining the second bitrate is based on predicted values for the network latency, the presence of the map of the environment, the second bitrate of the map of the environment, and the speed of the mobile device.

24-27. (canceled)

28. A non-transitory computer readable medium comprising instructions, that when executed by a processor, perform operations comprising: receiving image data of an environment from an image sensor of a mobile device at a first bitrate;
receiving a first model that predicts localization performance as a function of:
network latency, and
the first bitrate of the image data;
determining, utilizing the first model, a second bitrate for transmission of image data that improves the localization performance;
encoding the image data at the second bitrate to generate compressed image data; and
transmitting the compressed image data to a network node.

29-40. (canceled)
